(19) United States
(12) Patent Application Publication
(10) Pub. No.: US 2007/0202226 A1
(43) Pub. Date: Aug. 30, 2007

(54) Packaged frozen foods and methods for preparation

(76) Inventor: Sherry Dang, Watsonville, CA (US)

Correspondence Address: CENTRAL COAST PATENT AGENCY, INC, 3 HANGAR WAY SUITE D, WATSONVILLE, CA, 95076, US

(21) Appl. No.: 11/361,413

(22) Filed: Feb. 24, 2006

(51) Int. Cl. A23B 4/06

(52) U.S. Cl. 426/393

(57) ABSTRACT

A frozen food product has one or more food items selected to provide to a human being a specific proportion of a published daily requirement of nutritional value, the food items quick frozen, and encased in a sealed polymer envelope. A computerized system relates stored data about clients and products to select products for the client.

### BACKGROUND OF THE INVENTION

1. Field of the Invention

The present invention is in the field of packaged foodstuffs, and pertains more particularly to materials and methods providing increased convenience for a user.

2. Discussion of the State of the Art

Many methods and combinations in the preparation and packing of foodstuffs are well known in the art. An interested party might review many of these conventional techniques and products simply by visiting the frozen food section of any conventional supermarket. It is known, for example, to provide several different foodstuffs in a single container, such as a paper or a plastic plate, to make a complete meal. There may be in such a combination a meat component, such as, for example, a piece of cooked ground beef, which may be topped with gravy, for example, a carbohydrate, such as mashed potatoes, a vegetable component, such as green beans, and sometimes a dessert component, such as frozen custard.

Frozen dinners, such as the example provided above, provide a real convenience for may people who have a busy lifestyle, or whom for one reason or another find it difficult or inconvenient to prepare their own meals. One need only select the frozen dinner, take it home, and prepare it by placing a few minutes in a microwave oven, or immersion in boiling water, for example.

Even though frozen dinners like those described above provide a large measure of convenience for persons, and even though ingredients, calorie content, percentage of fats, and so on are typically listed on a label with the product, and in some cases even required by law, there is no attempt with such products to really provide just the right amount of calories, fats, proteins, vitamins, and so forth that a person might really need the particular meal represented by the product. In point of fact, more attention is paid in the presentation and preparation of such products to eye and appetite appeal than to proper nutrition. Although there is convenience, regular use of such products may well not be really healthy for the user.

Further to the above, there are other needs that are unmet by conventional frozen food products. For example, most such products are provided in other than robust packaging, such that uses are somewhat limited. A person who commutes to work, for example, typically cannot take such frozen products when leaving for work in the morning, and expect the products to remain frozen, and therefore fresh, until lunchtime, unless the user packs the frozen product or products in an insulated container.

In addition to the above, it is quite common for purchasers of frozen, packed foods to discover that they do not have condiments at the point of consumption that they might desire to enhance the taste and appeal of the frozen product, although frozen meals may be packaged with gravy for the mashed potatoes, for example, it is not common to provide condiments with such products.

Given the unmet needs and problems detailed above, what is needed is a system of frozen foods in which calorie content, percentage of fats, amount of proteins, presence of vitamins, and so on are strictly controlled and related to customers life styles special needs, such as a need to lose, gain, or maintain weight, that may be packaged in a manner that provides additional convenience for the busy customer, and in which desirable condiments may be combined for added convenience for the customer.

### SUMMARY OF THE INVENTION

In a preferred embodiment of the invention a frozen food product comprising one or more food items selected to provide to a human being a specific proportion of a published daily requirement of nutritional value is provided, the food items quick frozen, and encased in a sealed polymer envelope.

In some embodiments the frozen food items comprise selected fruits and in some embodiments the items comprise selected vegetables. In some embodiments the food items are organic, and tested to be free of pesticides or other foreign chemicals.

In some embodiments the polymer envelope is constructed to include a layer of insulating material other than the polymer to insulate the food items to keep the items frozen. In some cases the polymer envelope includes a polymer layer with closed air cells as an insulative layer.

In some embodiments there are two or more separate sealed pockets, one pocket containing the one or more food items, and a second pocket containing one or more condiments and/or vitamins, and wherein the nutritional value of the condiments and/or vitamins is included in the total nutritional value. Also in some embodiments the condiments include one or more of salad dressing, nuts, raisins, catsup, sugar, kosher salt, or vinegar. Further in some embodiments there are three pockets, one pocket containing the food items, a second pocket containing the one or more condiments, and a third pocket containing the vitamins.

In another aspect of the invention a frozen food product comprising one or more food items selected to provide to a human being a specific proportion of a published daily requirement of nutritional value is provided, the food items pureed into a smooth fluid, quick frozen, and encased in a sealed polymer envelope. In some embodiments the frozen food items comprise selected fruits, and in some embodiments selected vegetables. Also in some embodiments the food items are organic, and tested to be free of pesticides or other foreign chemicals.

In some embodiments the polymer envelope is constructed to include a layer of insulating material other than the polymer to insulate the food items to keep the items frozen. The envelope may include a polymer layer with closed air cells as an insulative layer. In other embodiments there may be two or more separate sealed pockets,one pocket containing the one or more food items pureed, and a second pocket containing one or more condiments and/or vitamins, and wherein the nutritional value of the condiments and/or vitamins is included in the total nutritional value. The condiments may include one or more of salad dressing, nuts, raisins, catsup, sugar, kosher salt, or vinegar. In an alternative embodiment there are three pockets, one pocket containing the food items, a second pocket containing the one or more condiments and a third pocket containing the vitamins. In some cases fruit or vegetable juices may be used, and in some embodiments vitamins are pureed into the smooth fluid.

In yet another aspect of the invention a frozen food product comprising multiple food items including an entree and accompanying foods is provided comprising a complete meal, the entree and at least one of the accompanying foods occupying separate sealed pockets in a polymer encasement. The food items in total are selected to provide to a human being a specific proportion of a published daily requirement of nutritional value, and are cleaned and quick frozen. In various embodiments the accompanying items in separate pockets comprise one or more of fruits, vegetables, and dessert items. In some cases there are one or more additional pockets containing condiments of vitamins, the condiments or vitamins included in the total nutritional value of the product. In some cases the polymer encasement is constructed to include a layer of insulating material other than the polymer to insulate the food items to keep the items frozen. The insulative layer may be a polymer layer with closed air cells.

In yet another aspect of the invention a multiple-unit frozen food product is provided comprising a first unit having multiple food items including an entree and accompanying foods comprising a complete meal, the entree and at least one of the accompanying foods occupying separate sealed pockets in a polymer encasement of the first unit, a second unit connected by a tear-off interface to the first unit, the second unit having multiple food items including an entree and accompanying foods comprising a complete meal, the entree and at least one of the accompanying foods occupying separate sealed pockets in a polymer encasement of the second unit. The food items in each unit in total are selected to provide to a human being a specific proportion of a published daily requirement of nutritional value, and are cleaned and quick frozen.

In some embodiments there are three units, a first unit having food items constituting a breakfast, a second unit having food items constituting a lunch, and a third unit constituting a dinner, the three units together selected to have total nutritional value equal to a published daily requirement for a human. In some embodiments there is a breakfast unit, a lunch unit, and a dinner unit, connected sequentially by tear-off interfaces, comprises a one-day set, the product comprising repeating one day sets connected by tear-off interfaces.

In still another aspect a computerized system for selecting food products for clients, comprising stored data of nutritional values of available food products, a stored personal profile for a client, defining at least weight, height, gender, and life-style of the client, and logic operating on the system relating nutritional values of available food products to details of the stored personal profile for the client, and selecting food products for the client accordingly. In some embodiments the stored profile includes personal goals of the client, and the logic operates to select products for the client that promotes the personal goals of the client.

In still another aspect of the invention a method for selecting food products for a client is provided, comprising steps of (a) storing data of nutritional values of available food products; (b) storing a personal profile for the client, the profile including at least weight, height, gender, and life-style of the client; and (c) executing logic on the system relating nutritional values of available food products to details of the stored personal profile for the client, and selecting food products for the client accordingly. In certain embodiments in step (b) the stored profile includes personal goals of the client, and the logic operates to select products for the client that promotes the personal goals of the client.

### BRIEF DESCRIPTION OF THE DRAWING FIGURES

FIG. 1a is a plan view illustration of a packed frozen food item in an embodiment of the present invention.

FIG. 1b is a side elevation view in the direction toward the short end of the packaged item of FIG. 1a.

FIG. 2 illustrates another product including condiments in an embodiment of the present invention.

FIG. 3 illustrates a packed frozen food product combined with vitamins according to an embodiment of the present invention.

FIG. 4a is a plan view of an integrated frozen product according to an alternative embodiment of the present invention.

FIG. 4b is a side elevation view of the integrated product of FIG. 4a.

FIG. 5 illustrates a frozen meal product in another embodiment of the present invention.

FIG. 6 illustrates a plan view of a meal strip 600 comprising multiple meal items.

FIG. 7 illustrates an interface to a website in an embodiment of the present invention.

### DETAILED DESCRIPTION

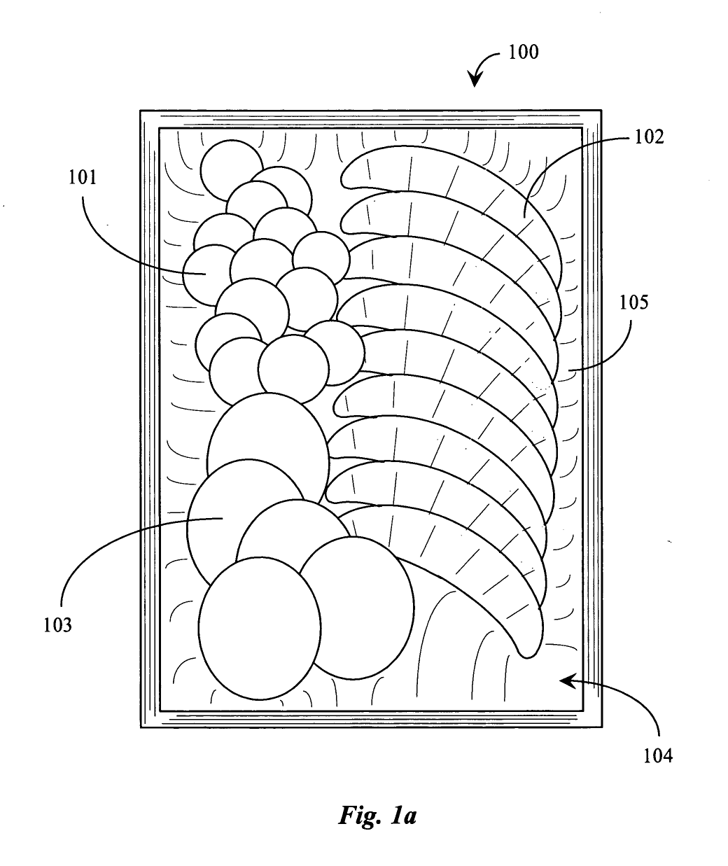

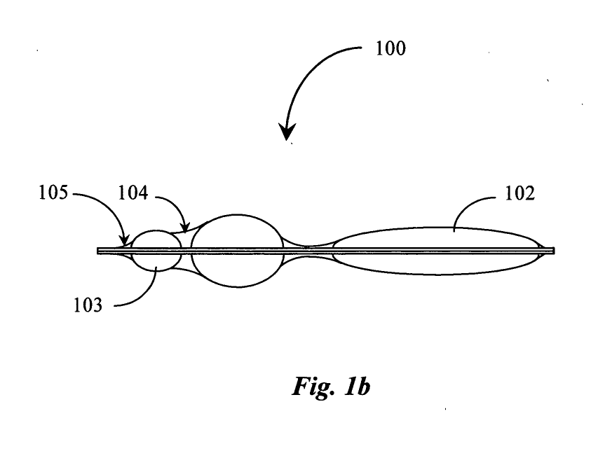

FIG. 1a is a plan view illustration of a packaged frozen food item 100 in an embodiment of the present invention. FIG. 1b is a side elevation view of the item of FIG. 1a. Item 100 includes, in this particular embodiment, a combination of prepared fruit or vegetable portions 101, 102 and 103 vacuum packed in a plastic encasement 104 and flash frozen, not necessarily in that order. In the particular embodiment shown portions 101 represent cherries, portions 102 represent orange slices and portions 163 represent pitted peach halves, but the items could be more or fewer, and could be any combination of fruits or vegetables. The fruit or vegetable portions are carefully selected from high quality produce, carefully washed and tested to assure freedom from any foreign matter, pesticide or other chemicals, and are vacuum packed in plastic encasement 104. The plastic encasement is made of a heat-sealable polymer material, and in the embodiment shown a top and a bottom sheet of substantially the same shape and area are heat sealed together under vacuum, forming heat seal border 105 completely around the periphery of item 100.

FIG. 1b shows the general relationship between the vegetable and fruit portions and the plastic encasement after heat sealing. The plastic material for encasement 104 is shown as expected to deform after vacuum packing and returning to atmosphere pressure. The shape is much the same as would be accomplished by shrink-wrapping.

In some embodiments the encasement may be a bag closed on three sides, allowing final sealing to be done only on the open side. The material of the encasement may vary, and the thickness of the polymer material may vary in various embodiments. There are a number of procedures well-known in the art for vacuum processing, flash freezing, and heat sealing to accomplish packaging of the fruit and vegetable items as shown.

There are at least two guiding criteria in preparing packaged frozen foods according to the present invention. One is selecting only the best fruit and vegetables, and in one embodiment only organic produce is used. Another is in caloric and vitamin content, and recommended nutrients daily for particular fruits and vegetables. For example, there are a number of organizations that test foodstuffs against human needs and publish recommended daily requirements, such as the Mayo Clinic and the United States Federal Government. In an embodiment of the present invention combinations of fruits and vegetables are selected and packaged according to dual criteria: one for ethnic interest, and the other criteria for nutritional content.

As an example of the a packaged unit as shown in FIGS. 1a and 1b created according to the dual criteria described above, and particular package might contain three different vegetables indigenous to and commonly used in Mexico, and having nutritional value recommended as a minimum daily requirement for vegetables. Another example might combine vegetables common to Vietnam also providing a minimum daily requirement of nutrients typically available in vegetables.

In one embodiment of the invention encasement 104 is made of a material having a greater-than-usual thickness, and also having a closed-cell construction, meaning that the material has relatively evenly distributed small air bubbles throughout, which act as an effective heat insulation material, in this case to keep heat out, so the frozen foodstuff within the package may be transported without an insulated container, and still be expected to remain frozen for a considerable length of time. For example, a person may be able to pack frozen units according to an embodiment of this invention in a paper bag early in the morning, and the units will still be frozen at lunch time.

In an alternative embodiment the encasement material is a layered material having a layer of highly insulative material between two layers of plastic. In another embodiment the middle layer may be a highly reflective material which will reflect rather than absorb heat.

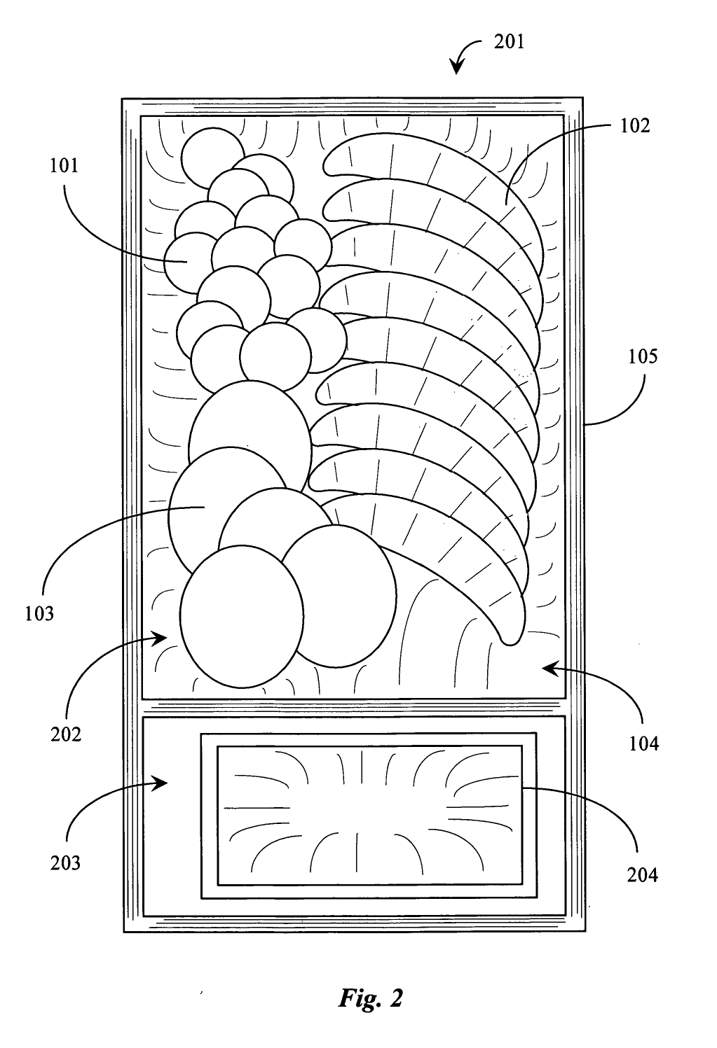

FIG. 2 is a plan view of another frozen food item 201 including condiments in an embodiment of the present invention. In this embodiment there are two pockets 202 and 203 in the encasement. The first pocket 202 contains frozen fruits or vegetables, just as described above with reference to FIGS. 1a and 1b. The second pocket 203 carries one or more condiments 204, such as a package of salad dressing as shown. Other condiments may be carried in pocket 203, such as nuts, raisins, catsup, sugar, kosher salt, vinegar, or any other of a broad variety of materials which may be considered condiments, either singly or in combination, selected for use with the contents of the first pocket in the encasement.

In selecting content and condiments together for frozen food items with two pockets and condiments separately packed, the total nutritional value is taken into account, and selections are made to provide a unit that provides a specific requirement of such as calories, vitamins, minerals and the like, and in many cases. In some cases the selection will provide a specific portion of a requirement to be combined with other units to make up a meal requirement, or a minimum daily requirement, for example.

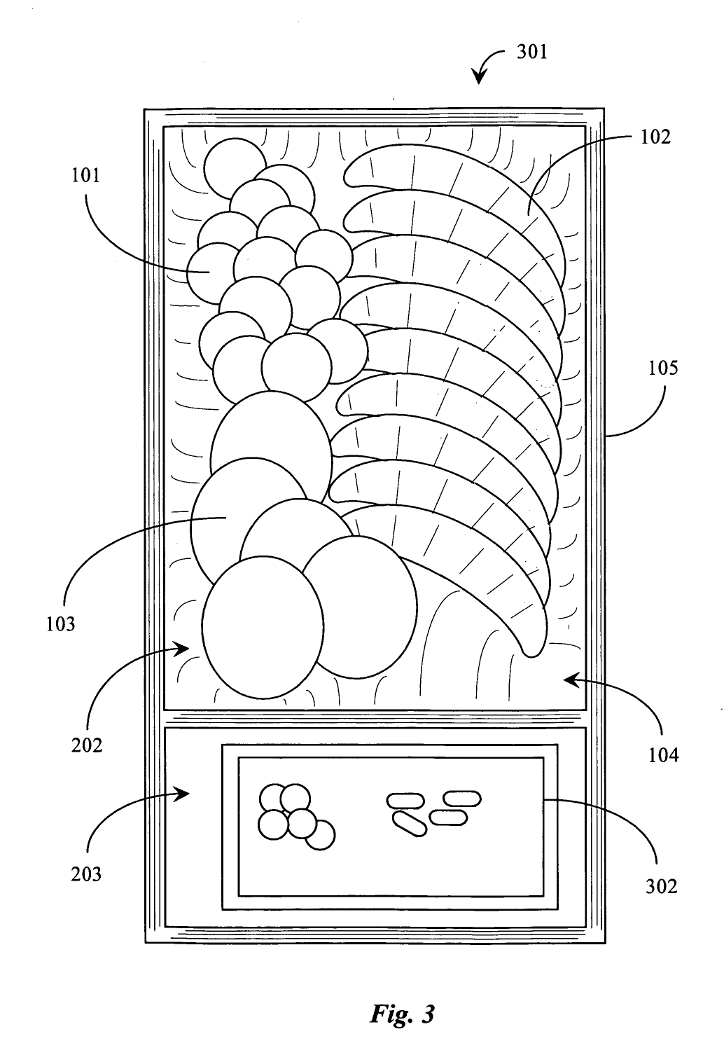

FIG. 3 illustrates a packed frozen food item 301 having two pockets 202 and 203 as in the embodiment described above with reference to FIG. 2, with the second packet dedicated to vitamins according to an embodiment of the present invention. In FIG. 3 several capsules and tablets of vitamins are shown as element 302, but the number type and form may vary. Selection of vitamins is made to supplement the nutritional value known to exist in the foodstuffs, and selection is made to provide a specific portion of the minimum daily requirement of various types of vitamins, such as 50% of the requirement for vitamin C or 30% of the requirement for vitamin D.

In alternative embodiments of the invention the encasement may have more than two pockets. A three-pocket encasement, for example, may have selected fruits or vegetables, condiments, and vitamins, all in separate pockets.

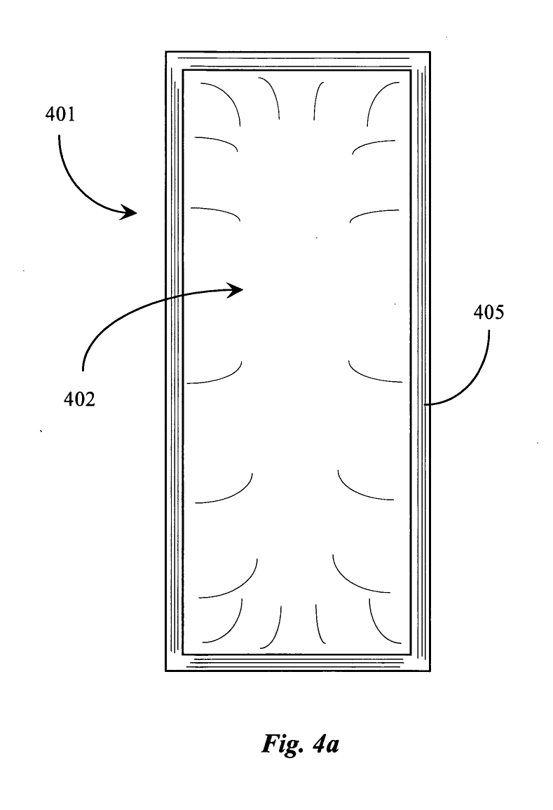

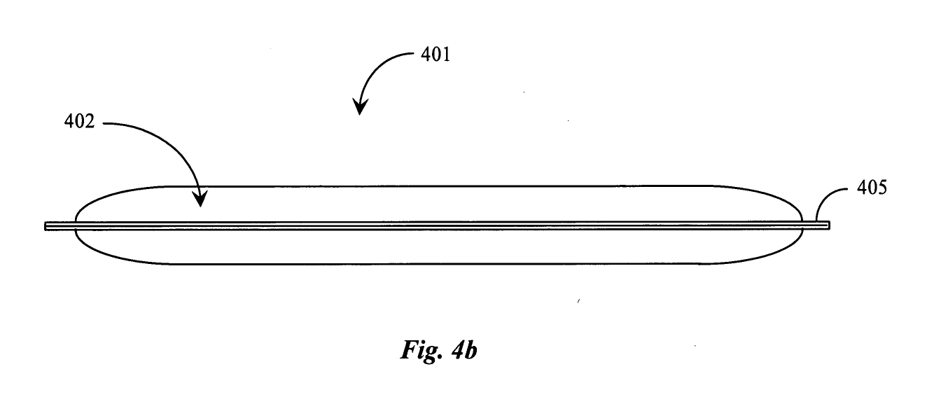

FIG. 4a is a plan view of an integrated frozen food item 401 according to an alternative embodiment of the present invention. FIG. 4b is a side elevation view of the frozen product of FIG. 4a. The inventor terms the content of the frozen food item in FIG. 4a and FIG. 4b a fruit or vegetable smoothie. To produce the smoothie fruits or vegetables are selected according to the criteria described above, providing a specific portion of a daily requirement of nutrients, and then carefully washed, in some cases cooked, ground and pureed, and then flash frozen. In some cases fruit or vegetable juices are included in the mix before the puree process to improve the consistency of the final product. Also in some cases vitamins, minerals and other ingredients may be added to accomplish a specific goal for a final product.

Smoothie frozen items according to embodiments of the present invention may also be produced with extra insulated encasement as described above, and also with multiple pockets having either condiments of vitamins as also described above.

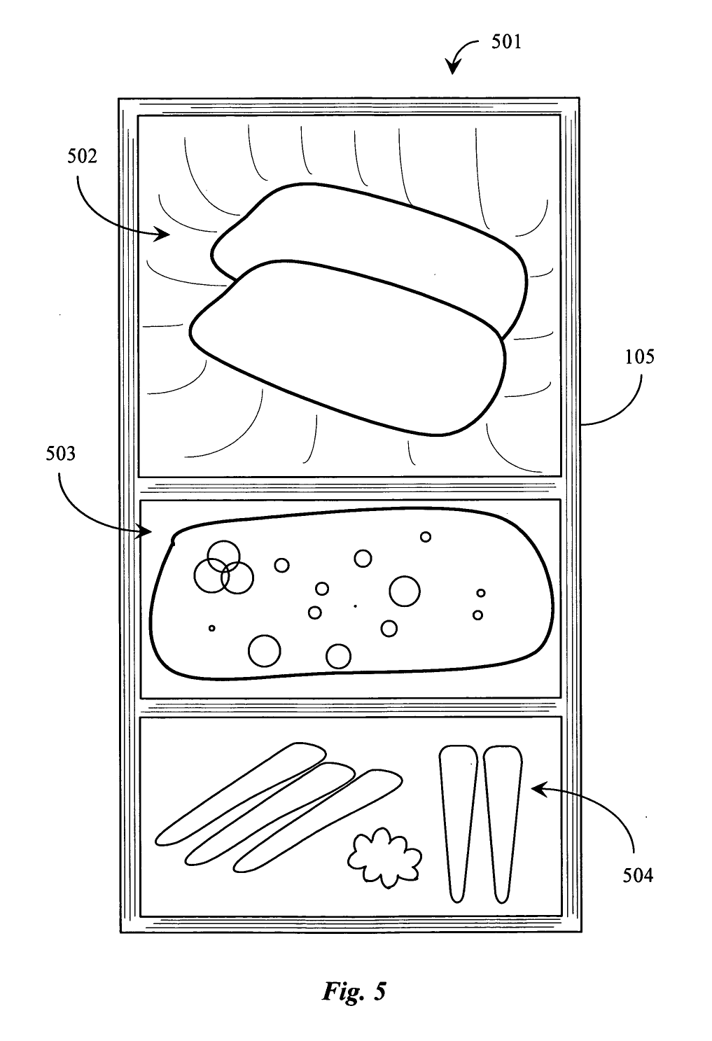

FIG. 5 is a plan view of a frozen meal item 501 according to an 502, 503 and 504 in the polymer encasement, and each of the three pockets encloses a different component of a complete meal. In this example pocket 502 contains two pieces of chicken, pocket 503 contains a soup of vegetables and broth, and pocket 504 contains an assortment of vegetables, which were cooked before freezing, as was the chicken and the soup. As in other embodiments of this invention the total nutritional value of the components of meal 501 is very carefully controlled to be a pre-selected value according to published daily requirements for such as vitamins, minerals, calories and the like.

In alternative embodiments of the invention a meal such as meal 501 may have different food items in pockets, such as, for example, a dessert item, and may have additional pockets in the encasement for such as condiments or separate vitamins, and in these cases as well, total nutritional value is carefully controlled according to published requirements.

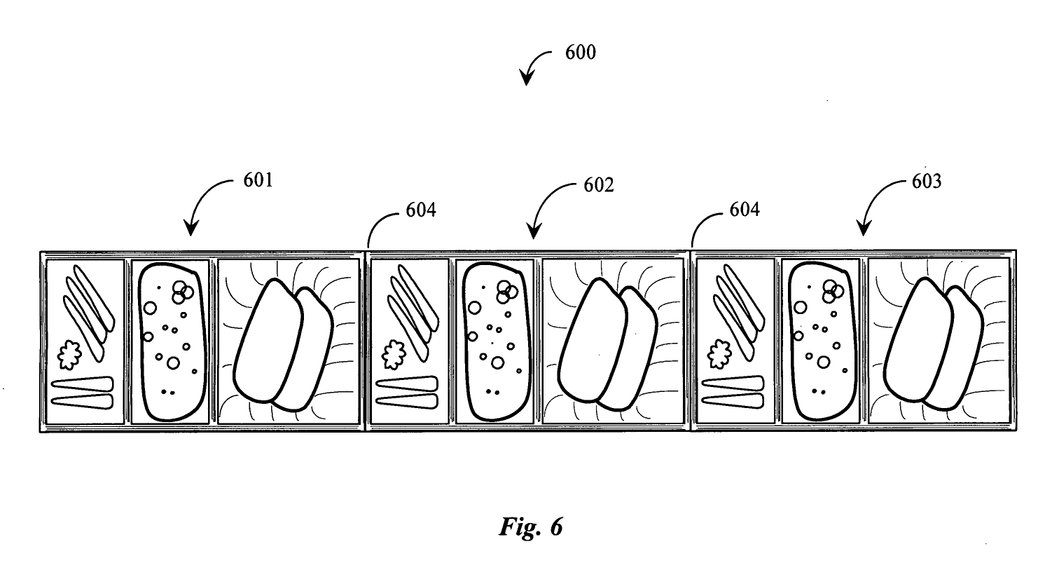

FIG. 6 is a plan view of a meal strip 600 comprising multiple meal items 601, 602 and 603 connected by a tear off strip 604 between each meal in another embodiment of the present invention. In the meal strip shown the meals are the same. In alternative embodiments there may be more than three meals in a meal strip, and in some embodiments the meals may differ. For example, in one embodiment there are three different meals connected side by side in order in a sequence, one with ingredients selected for breakfast, a second with ingredients selected for lunch, and in a third ingredients for dinner. In some embodiments this sequence repeats, providing a one-day meal package, and in other embodiments different meals are selected in a sequence for breakfast lunch and dinner for one day, such as Monday, and a different sequence with different ingredients for Tuesday, and so on, providing a meal strip with different meals selected for an entire week, providing variety and very carefully selected nutritional value. In yet another embodiment, meals may be prepared for a much longer period of time, providing both variety and carefully selected nutritional needs.

In various embodiments of the invention a unique aspect is in the selection and preparation of items and meals according to a carefully determined plan of nutritional value. In one embodiment the preparation and selection is optimized for persons in relatively narrow bands of need. For example, a series of meals may be established for active females within a certain height and weight range. A different, but perhaps quite similar series may be established for females in a somewhat different height and weight range, and there may be some overlap in ranges. Further, different ingredients, condiments and vitamins, for example, may be included according to other personal characteristics. For example, in one embodiment, adjustments are made depending on a person's job. A product may be provided with sequential frozen meals for a male construction worker who weighs between two-hundred and two-hundred-fifty pounds, based on an oriental theme, providing just the exact requirements of nutrition and vitamins, including protein, carbohydrates, and the like, to maintain weight and good health for just such a person.

In another embodiment adjustments to product content may be made for personal goals. For example, for a male office worker moderately overweight, who may have a goal of shedding ten pounds over a period of ten weeks. Products may be created according to embodiments of the invention for gaining weight over specified time periods as well. Other combinations may be dedicated to persons training for long-distance running, or for a triathlon, for example. Almost any personal need, goal, body type, gender, ethnic preference, and so on may be accommodated.

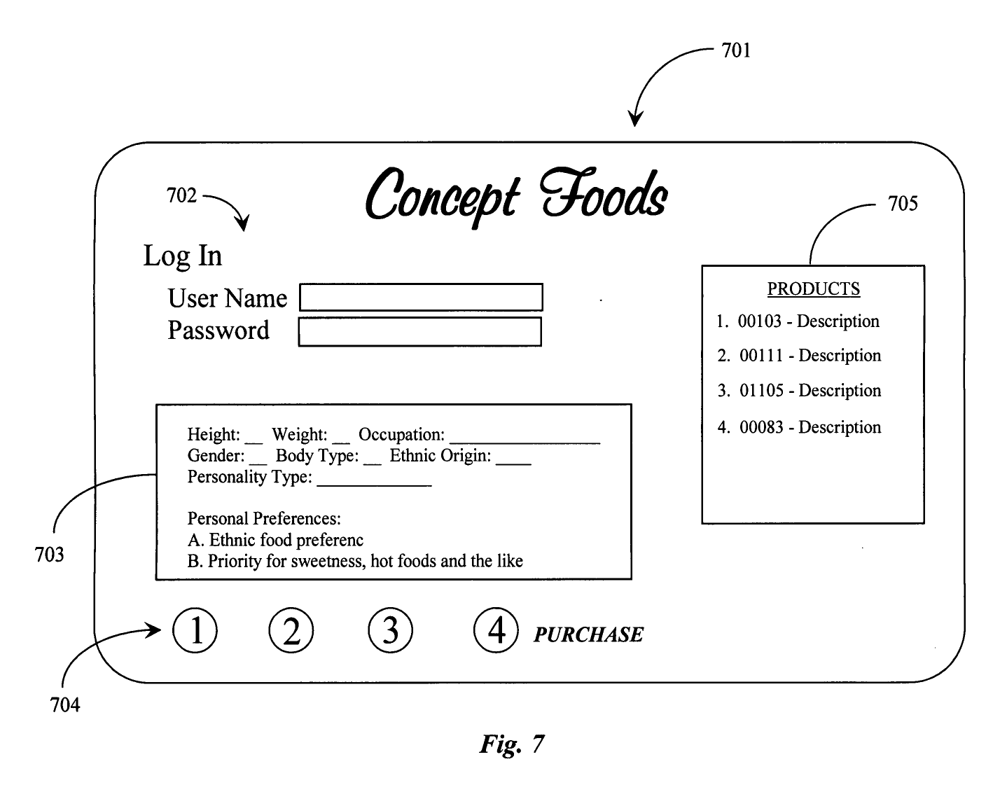

FIG. 7 is an illustration of a display 701 on a computer screen providing an interactive interface to stored logic and functions (Concept Food System) at a web site in one embodiment, for a user to enter a personal profile, and to make product selections from a set of available products based on that personal profile. A web site in the well-known Internet is one example and embodiment, but the functionality may be provided in other ways, such as by a program and data provided to a user on a CD to be used on an individual PC. In this case the user might only need to communicate product choices for delivery by, for example, telephone. In some cases the same sort of functionality may be provided in a call center.

The interface to a web site as shown in FIG. 7 has a Log In function 702 where a person may enter a username and a password to gain access as is well-known in the art. Configuration functions, also well-known in the art are provided (but not shown) for a person to join and become a client of the site. A plurality of links 704 are provided through which a user may access certain functions, such as the configuration function mentioned above, and other functions such as a personal profile window 703, where a user may enter and create a personal profile, describing personal characteristics, lifestyle, personality, preferences ion a number of areas, priorities, and the like. Many of the categories in such a function may be optional, and there may be drop-down for many of the items for a user to simply select from a menu of responses.

In embodiments of the invention there may be product displays and lists such as list 705 for imparting knowledge to users about available products, and a purchase function whereby a user may select and purchase products. In one embodiment a user may elect to have the Concept System select products, such as a sequence of meals for a week or a month, or for a tailored time period, from available products. Selection in this instance is based on the user's personal profile, and in at least one embodiment the user is offered an opportunity once selection is made to make personal edits and adjustments. There may also be input for a user to select among certain characteristics in selection, or the user may be offered options, such as Carrot Cake or Chocolate Cake for dessert.

The Concept Foods System in a preferred embodiment of the invention provides a means for a client to easily tailor a personal consumption program, and to have foods delivered on a schedule to accomplish the program. As an example, an active young woman may create a personal profile including a weight loss goal, and then use the system to create a complete consumption profile through accomplishment of the goal.

In various embodiments of the invention a client can alter the personal profile at any time, either by preference or by actual change in criteria. For example, a client with a weight loss goal may move from one weight category to a lower weight category, and updating the personal profile will allow the system to more closely tailor consumption to the client's preferences and needs.

In yet another embodiment of the invention the Concept Food System maintains a database storing and utilizing diverse publicly-available information about exercise programs, exercise related to calorie burning and the like, as well as nutritional information and available food products providing specific nutritional needs in a balanced fashion, and the system may make recommendations for exercise along with nutritional intake and specific product recommendations to accomplish specific goals.

In the area of specific goals, a client may, for example, have a goal of weight gain, weight loss, weight maintenance, muscle building, muscle softening, and more, and all may be taken into account in providing recommendations and products to clients, such that the clients may rely on the system. In certain embodiments the clients are offered opportunity to provide feed back to the system for the system to use in ongoing operations pertaining to the particular client.

In a general process, logic operating on the Concept Foods system selects products for a client based on the client's personal profile and on stored data relating to daily requirements of nutrients for humans and nutritional value of available products. Given a client's personal profile, preferences, and goals, such as weight loss or weight gain for example, and given the stored data relating to nutritional requirements for humans according to weight, activity, and so on, products are selected for the client to lead to the client's accomplishing the goals in the client's personal profile. As an example, if a client is a female with an active life style who runs three miles per day, prefers oriental food and has a second priority p[reference for Italian food, and has a goal to gain three pounds over a two week period, the system selects meal strips predominantly oriental in style, intermingled with some units Italian in style, and having nutritional value that is calculated to be a value that will result in a woman of the client's size and weight gaining three pounds in weight over a two-week period, while maintaining exactly the minerals, vitamins, etc. that a woman of her size, weight, and life style needs. This is but a single example of many possible examples.

It will be apparent to the skilled artisan that there may be many changes made in the embodiments described above without departing from the spirit and scope of the invention. For example, the design of the interactive interface for a web site may be accomplished in many different ways in different embodiments of the invention. Different programmers may accomplish the same functions in a variety of ways. There also may be many different ways that meal sequences may be produced, and many ways the system may structure continuing sequences of meal selections and the like, perhaps mixing different products to provide new combinations. The invention should be afforded the scope of the claims that follow:

I claim:

1. A frozen food product comprising one or more food items selected to provide to a human being a specific proportion of a published daily requirement of nutritional value, the food items quick frozen, and encased in a sealed polymer envelope.

2. The product of claim 1 wherein the frozen food items comprise selected fruits.

3. The product of claim 1 wherein the frozen food items comprise selected vegetables.

4. The product of claim 1 wherein the food items are organic, and tested to be free of pesticides or other foreign chemicals.

5. The product of claim 1 wherein the polymer envelope is constructed to include a layer of insulating material other than the polymer to insulate the food items to keep the items frozen.

6. The product of claim 1 wherein the polymer envelope includes a polymer layer with closed air cells as an insulative layer.

7. The product of claim 1 comprising two or more separate sealed pockets, one pocket containing the one or more food items, and a second pocket containing one or more condiments and/or vitamins, and wherein the nutritional value of the condiments and/or vitamins is included in the total nutritional value.

8. The product of claim 7 wherein the condiments include one or more of salad dressing, nuts, raisins, catsup, sugar, kosher salt, or vinegar.

9. The product of claim 7 comprising three pockets, one-pocket containing the food items, a second pocket containing the one or more condiments, and a third pocket containing the vitamins.

10. A frozen food product comprising one or more food items selected to provide to a human being a specific proportion of a published daily requirement of nutritional value, the food items pureed into a smooth fluid, quick frozen, and encased in a sealed polymer envelope.

11. The product of claim 10 wherein the frozen food items comprise selected fruits.

12. The product of claim 10 wherein the frozen food items comprise selected vegetables.

13. The product of claim 10 wherein the food items are organic, and tested to be free of pesticides or other foreign chemicals.

14. The product of claim 10 wherein the polymer envelope is constructed to include a layer of insulating material other than the polymer to insulate the food items to keep the items frozen.

15. The product of claim 10 wherein the polymer envelope includes a polymer layer with closed air cells as an insulative layer.

16. The product of claim 10 comprising two or more separate sealed pockets, one pocket containing the one or more food items pureed, and a second pocket containing one or more condiments and/or vitamins, and wherein the nutritional value of the condiments and/or vitamins is included in the total nutritional value.

17. The product of claim 16 wherein the condiments include one or more of salad dressing, nuts, raisins, catsup, sugar, kosher salt, or vinegar.

18. The product of claim 16 comprising three pockets, one pocket containing the food items, a second pocket containing the one or more condiments, and a third pocket containing the vitamins.

19. The product of claim 10 comprising one or more fruit or vegetable juices.

20. The product of claim 10 comprising vitamins pureed into the smooth fluid.

21. A frozen food product comprising:
multiple food items including an entree and accompanying foods comprising a complete meal, the entree and at least one of the accompanying foods occupying separate sealed pockets in a polymer encasement;
wherein the food items in total are selected to provide to a human being a specific proportion of a published daily requirement of nutritional value, and are cleaned and quick frozen.

22. The product of claim 21 wherein the accompanying items in separate pockets comprise one or more of fruits, vegetables, and dessert items.

23. The product of claim 21 further comprising one or more additional pockets containing condiments of vitamins, the condiments or vitamins included in the total nutritional value of the product.

24. The product of claim 21 wherein the polymer encasement is constructed to include a layer of insulating material other than the polymer to insulate the food items to keep the items frozen.

25. The product of claim 24 wherein the polymer encasement includes a polymer layer with closed air cells as an insulative layer.

26. A multiple-unit frozen food product comprising:
a first unit having multiple food items including an entree and accompanying foods comprising a complete meal, the entree and at least one of the accompanying foods occupying separate sealed pockets in a polymer encasement of the first unit; and
a second unit connected by a tear-off interface to the first unit, the second unit having multiple food items including an entree and accompanying foods comprising a complete meal, the entree and at least one of the accompanying foods occupying separate sealed pockets in a polymer encasement of the second unit;
wherein the food items in each unit in total are selected to provide to a human being a specific proportion of a published daily requirement of nutritional value, and are cleaned and quick frozen.

27. The product of claim 26 comprising three units, a first unit having food items constituting a breakfast, a second unit having food items constituting a lunch, and a third unit constituting a dinner, the three units together selected to have total nutritional value equal to a published daily requirement for a human.

28. The product of claim 27 wherein a breakfast unit, a lunch unit, and a dinner unit, connected sequentially by tear-of interfaces, comprise a one-day set, the product comprising repeating one day sets connected by tear-off interfaces.

29. A computerized system for selecting food products for clients, comprising:
stored data of nutritional values of available food products;
a stored personal profile for a client, defining at least weight, height, gender, and life-style of the client; and
logic operating on the system relating nutritional values of available food products to details of the stored personal profile for the client, and selecting food products for the client accordingly.

30. The system of claim 29 wherein the stored profile includes personal goals of the client, and the logic operates to select products for the client that promotes the personal goals of the client.

31. A method for selecting food products for a client, comprising steps of:
(a) storing data of nutritional values of available food products;
(b) storing a personal profile for the client, the profile including at least weight, height, gender, and life-style of the client; and
(c) executing logic on the system relating nutritional values of available food products to details of the stored personal profile for the client, and selecting food products for the client accordingly.

32. The method of claim 31 wherein in step (b) the stored profile includes personal goals of the client, and the logic operates to select products for the client that promote the personal goals of the client.
